(19) United States
(12) Patent Application Publication
(10) Pub. No.: US 2023/0232855 A1
(43) Pub. Date: Jul. 27, 2023

(54) Biodegradable and Dissolvable Consumable Pod and a Method of Preparing an Instant Consumable

(71) Applicants: Ruben Perez, Chipley, FL (US); Maria Perez, Chipley, FL (US)

(72) Inventors: Ruben Perez, Chipley, FL (US); Maria Perez, Chipley, FL (US)

(21) Appl. No.: 17/864,531

(22) Filed: Jul. 14, 2022

Related U.S. Application Data
(60) Provisional application No. 63/303,254, filed on Jan. 26, 2022.

(51) Int. Cl. A23F 5/38; B65D 65/46; A23F 3/32

(52) U.S. Cl. CPC A23F 5/385; B65D 65/466; A23F 3/32

(57) ABSTRACT

The present invention relates to a water-soluble consumable or beverage pod and a method of making a consumable or beverage instantly using the pod. The beverage pod does not leave any trash and a cover covering the pod is also biodegradable. The consumable pod includes a sealed water-soluble body containing a consumable powder which can be a coffee powder, a tea powder, a baby formula powder, and a soup powder. The pod is dropped into water, enabling the body to dissolve, and mixing of consumable powder in the water for instantly preparing the consumable. In some embodiments, sugar is included in the consumable powder or in the sealed water-soluble body, and a liquid beverage concentrate can be used in place of the beverage powder. The pods and their storage bag/packaging are biodegradable to remain environmentally conscious when thrown away.

### CROSS-REFERENCE TO RELATED APPLICATION

The present application claims priority to, and the benefit of, U.S. Provisional Application No. 63/303,254, which was filed on Jan. 26, 2022 and is incorporated herein by reference in its entirety.

### FIELD OF THE INVENTION

The present invention relates generally to the field of consumables (i.e. coffee and tea), and a method of making consumables. More specifically, the present invention relates to a novel beverage or consumable pod for instantly making, for example, coffee or tea. The consumable pod includes a specific amount of, for example, dry coffee or tea product stored inside a cavity formed by a water-soluble body. The pod is dropped in water for preparing a beverage or consumable within seconds as the dry beverage product is mixed with the water and the water-soluble body is dissolved in water. The pod and a cover of the pod are biodegradable for reducing landfills waste. Accordingly, the present disclosure makes specific reference thereto. Nonetheless, it is to be appreciated that aspects of the present invention are also equally applicable to other like applications, devices, and methods of manufacture.

### BACKGROUND

By way of background, many people enjoy drinking coffee or tea as part of a daily routine. Preparing coffee and tea is time-consuming and typically requires one or several appliances to complete the beverage. This can be an inefficient use of time and energy. Coffee makers are bulky appliances which require electrical energy. Further, people who spend time outdoors may be unable to brew coffee or tea due to unavailability of coffee and tea makers.

Many people who go outdoors purchase sachets, bags, packets, or packages of coffee and tea powders for use. For making tea or coffee, an individual uses such a sachet, bag, or packet. Commonly, after removing beverage powder, such sachets, bags, packets, and packages are thrown away. As a result, tens of billions of such sachets, bags, packets, and packages, and more end up in landfills and create environmental hazards.

A common problem faced by people who love coffee and tea is unavailability of their favorite taste or a specific product. Accordingly, people end up having a beverage which they do not like and thus, desire a way that can offer a specific type or size of beverage product on a consistent basis.

Therefore, there exists a long felt need in the art for a dissolvable pod that can be easily placed in hot or cold water to instantly make coffee or tea. There is also a long felt need in the art for a beverage pod that is dissolved in water to make a beverage without any wastage. Additionally, there is a long felt need in the art for a dissolvable beverage pod that is biodegradable and environmentally friendly. Moreover, there is a long felt need in the art for a beverage pod that allows people to make coffee or tea easily outdoors or away from home. Further, there is a long felt need in the art for a beverage pod that can be provided to users through a subscription service. Furthermore, there is a long felt need in the art for beverage pods that that come in different flavors and roasts. Finally, there is a long felt need in the art for a beverage pod that allows users to create coffee or tea without large, bulky appliances in an environmentally friendly manner.

The subject matter disclosed and claimed herein, in one embodiment thereof, comprises a single use dissolvable beverage pod. The beverage pod is filled with specific types of either coffee or tea powder enabling instant preparation of the beverage. The beverage pod further comprising a body forming a cavity; the body is sealed and made from a water-soluble edible material; a dried beverage powder stored within the cavity; a biodegradable cover wrapping said body for protecting said beverage pod from surrounding environment, wherein the biodegradable cover is configured to be removed before dropping the beverage pod into water for forming a beverage without using any beverage making machine.

In this manner, the water-soluble beverage pod of the present invention accomplishes all of the forgoing objectives and provides users with a unique, dissolvable pod designed to be placed in boiling or cold water to make coffee or tea. The pod utilizes biodegradable and water-soluble materials to easily dissolve in the water and allows users to create coffee or tea without large, bulky appliances. The pods can be obtained through a membership or subscription service and helps in reducing waste in landfills.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a single use dissolvable coffee pod. The coffee pod further comprising a body forming a cavity; the body is sealed and made from a water-soluble edible material; a dried beverage powder stored within the cavity; a biodegradable cover wrapping said body for protecting said coffee pod from surrounding environment, wherein the biodegradable cover is configured to be removed before dropping the coffee pod into water for forming a beverage.

In yet another embodiment, the body is configured to protect the dried beverage powder from moisture and oxygen (i.e. airtight).

In yet another embodiment, the body is made from food grade polyvinyl alcohol (PVOH).

In yet another embodiment, the body dissolves completely upon contact with water to form a beverage.

In yet another embodiment, the body is a sugar shell that makes a beverage formed by the coffee pod sweet.

In yet another embodiment, the coffee pod comes in a biodegradable packaging of 12 pods, 24 pods, 36 pods, and more.

In yet another embodiment, the coffee pod is available to a consumer through a membership or subscription service wherein a consumer subscribes for at least one type of beverage pod for a predetermined duration and frequency.

In yet another embodiment, a soluble beverage product is disclosed. The soluble beverage product is designed in the form of a dissolvable pod and comprises a water-soluble food grade paper body forming a cavity; the body has a flavoring coating for imparting a flavor to the beverage; a dry beverage composition stored inside the cavity, the composition including coffee powder, milk powder, and sugar; and a biodegradable cover for protecting said body and the stored beverage composition from physical damage, tears, and damage.

In yet another embodiment, the soluble beverage product, when combined with water, can form between 8 oz and 25 oz of coffee.

In yet another embodiment, the soluble beverage product is round or semi-flat in shape.

In yet another embodiment, the beverage composition is a liquid coffee concentrate.

In yet another embodiment, a method of instantly preparing a single serving of coffee without using any coffee preparing machine is described. The method includes the steps of providing a dissolvable coffee pod, the coffee pod includes a dry coffee powder stored in a dissolvable food grade paper body and the coffee pod is covered by a biodegradable paper cover; unwrapping the biodegradable paper cover; dropping the coffee pod into a single serving of hot water; stirring the hot water to prepare the single serving of coffee.

In yet another embodiment, a method of instantly preparing a single serving of cold coffee without using any coffee preparing machine is described. The method includes the steps of providing a dissolvable coffee pod, the coffee pod includes a dry coffee powder and sugar stored in a dissolvable food grade paper body and the coffee pod is covered by a biodegradable paper cover; unwrapping the biodegradable paper cover; dropping the coffee pod into a single serving of cold water; stirring the cold water to prepare the single serving of cold coffee.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a water-soluble beverage pod of the present invention in accordance with the disclosed architecture;

FIG. 2 illustrates one potential embodiment of the water-soluble beverage pod packaging available commercially for consumers in accordance with the disclosed architecture;

FIG. 3 illustrates a schematic view of subscription or membership platform for the biodegradable beverage pods of the present invention in accordance with the disclosed architecture;

FIG. 4 illustrates a perspective view showing a beverage pod being dropped into a single serving of water for creating a beverage instantly in accordance with the disclosed architecture; and

FIG. 5 illustrates a cross sectional view of another embodiment of the water-soluble beverage pod of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a dissolvable pod that can be easily placed in hot or cold water to instantly make coffee or tea. There is also a long felt need in the art for a beverage pod that is dissolved in water to make a beverage without any wastage. Additionally, there is a long felt need in the art for a dissolvable beverage pod that is biodegradable and environmentally friendly. Moreover, there is a long felt need in the art for a beverage pod that allows people to make coffee or tea easily outdoors or away from home appliances/electricity. Further, there is a long felt need in the art for a beverage pod that can be provided to users through a subscription service. Furthermore, there is a long felt need in the art for beverage pods that that come in different flavors and roasts. Finally, there is a long felt need in the art for a beverage pod that allows users to create coffee or tea without large, bulky appliances in an environmentally friendly manner.

The present invention, in one exemplary embodiment, is a method of instantly preparing a single serving of coffee or tea without using any beverage preparing machine. The method includes the steps of providing a dissolvable beverage pod, the coffee pod includes a dry coffee or tea powder stored in a dissolvable food grade paper body and the beverage pod is covered by a biodegradable paper cover; unwrapping the biodegradable paper cover; dropping the beverage pod into a single serving of water; stirring the water to prepare the single serving of the beverage wherein the single serving of water is from about 8 ounces to about 25 ounces.

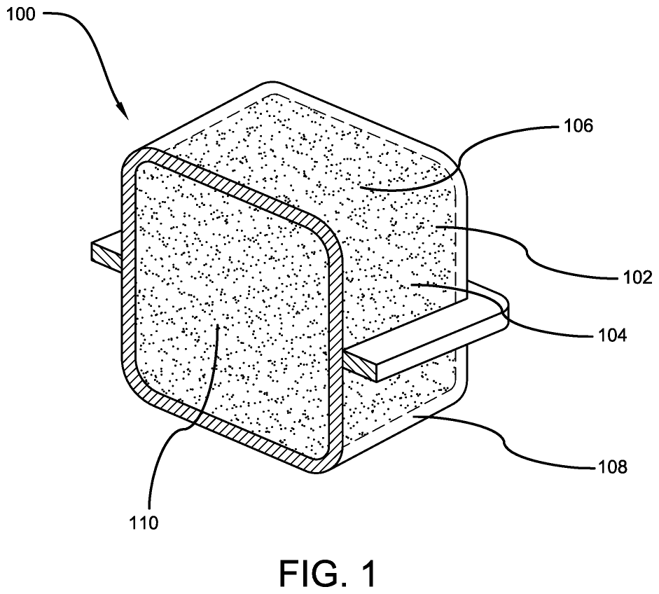

Referring initially to the drawings, FIG. 1 illustrates a perspective view of one potential embodiment of a water-soluble beverage pod 100 of the present invention in accordance with the disclosed architecture. The beverage pod 100 is designed to instantly make coffee or tea by dropping the pod 100 into boiling, hot, or cold water. More specifically, the pod 100 includes a sealed food grade paper body 102 configured in round or semi-flat shape and forms a cavity 104 for containing a specific amount of beverage powder 106 for preparation of a single serving of a beverage. In one exemplary embodiment, the beverage powder 106 can be a coffee powder or tea powder.

The sealed food grade paper body 102 is made of water-soluble, recyclable, or biodegradable material or combination of materials. The paper body 102 immediately, for example within 5-10 seconds, dissolves when it comes into contact with the water thereby enabling the stored beverage powder 106 to mix in the water. The paper body 102 is colorless and may include a coating of a flavoring agent. The paper body 102 can be made from food grade polyvinyl alcohol (PVOH) and whereby the paper body 102 protects the stored beverage powder 106 therein from moisture and oxygen (i.e. airtight). The paper body 102 has an overall capacity equal to the amount of the beverage powder 106 stored therein. In one exemplary embodiment, the paper body 102 can store beverage powder 106 from about 5 grams to about 25 grams depending on a size of the paper body 102 and the pod 100.

A pod 100 is covered with a biodegradable cover 108 for protecting the paper body 102 and the stored powder 106 therein from physical damage, water contact, and weather elements. The cover 108 can be made from plant-based material, biodegradable plastic, or more. The cover 108 is configured to be easily torn or unwrapped for accessing the paper body 102 and for dropping in a single serving of water to make either tea or coffee. The pod cover 108 also helps in preventing prematurely releasing of the beverage powder 106 from the sealed food grade paper body 102. In one exemplary embodiment, the cover 108 is waterproof and may have a logo or any other indicia 110 printed thereon.

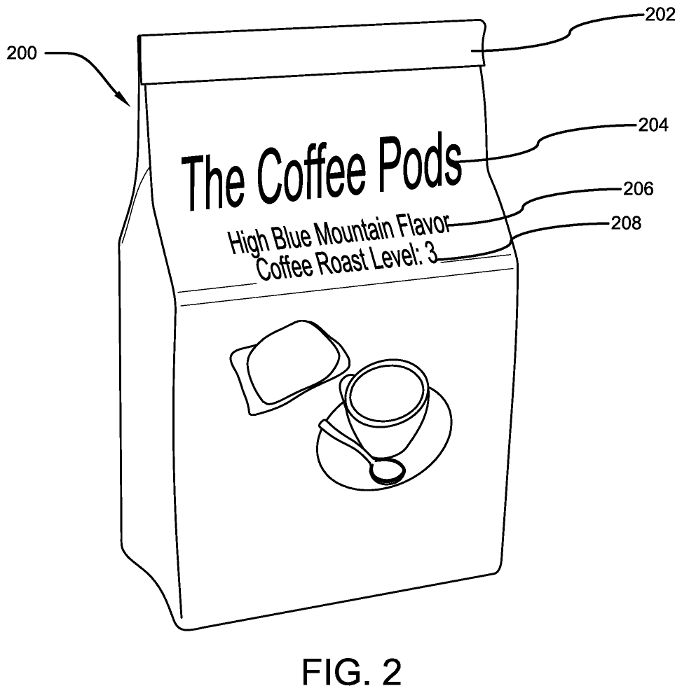

FIG. 2 illustrates one potential embodiment of the water-soluble beverage pod packaging available commercially for consumers in accordance with the disclosed architecture. The packaging container 200 is also made from biodegradable material and is environmentally friendly. The packaging container 200 comes in different sizes and may contain any number of pods, for example 12, 24, 36, or 50 pods. It should be noted that container 200 can come in different shapes and may accommodate any number of pods 100.

The packaging 200 can have a zippered opening 202 and may have a logo 204. Each pod 100 is individually and separately stored in the packaging 200 and can be accessed through the zippered opening 202. The packaging 200 can also include flavor information 206 and roast level information 208 of the pods 100 stored inside the packaging 200.

The packaging 200 comes in different colors and designs, and is lightweight in structure. A pod 100 can be easily pulled out of the packaging 200 for use and making a beverage anywhere without using any beverage making machine. The pods 100 and packaging or storage bag 200 are biodegradable to remain environmentally friendly when thrown away and the packaging 200 is printed in food grade ink.

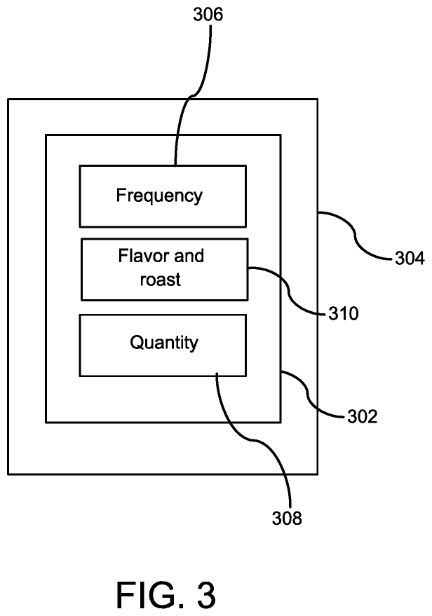

FIG. 3 illustrates a schematic view of subscription or membership platform for the biodegradable beverage pods of the present invention in accordance with the disclosed architecture. A computer implemented subscription application 302 configured to be installed in a computing device 304 is used by consumers for obtaining beverage pods 100. The application 302 is used for subscribing to the beverage pods at a predetermined frequency 306 such as weekly, monthly, quarterly, or more. A user can add the number (i.e. quantity) of packaging 308 that will be ordered to an address listed in profile of the user.

It should be appreciated that the beverage pods 100 can also be available over the counter. The pods 100 come in a variety of flavors like Blueberry, Cinnamon, Chocolate, Vanilla, and more. Based on the preferences of a user, a flavor and a roast level 310 can also be selected by a user using the application 302.

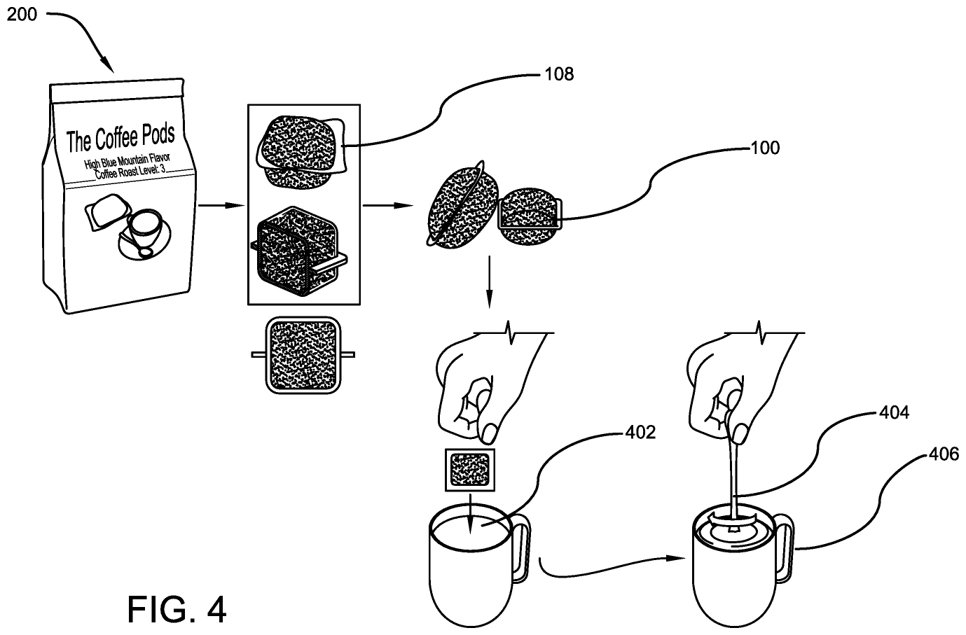

FIG. 4 illustrates a perspective view showing a beverage pod 100 being dropped into a single serving of water for creating a beverage instantly in accordance with the disclosed architecture. For use, a single beverage pod 100 wrapped in the biodegradable cover 108 is pulled from the packaging 200 and then, the cover 108 is unwrapped to access the body 102 storing the beverage powder 106. Then, the coffee pod 100 is dropped into the water 402 thereby enabling the body 102 to quickly dissolve in the water 402, preferably within 5-10 seconds. As the body 102 is dissolved, the beverage powder stored inside the body 102 is released into the water 402 and the water 402 is stirred using a stirrer 404 for creating a beverage 406.

It should be noted that the dissolvable beverage powder or consumable powder can be selected from a group consisting of a coffee powder, a tea powder, a baby formula powder, a soup powder, and other dissolvable consumables. Further, in one embodiment, the powder may have sugar for providing a sweet texture to the beverage. In another embodiment, the body 102 can be coated with sugar or other dissolvable flavoring agent.

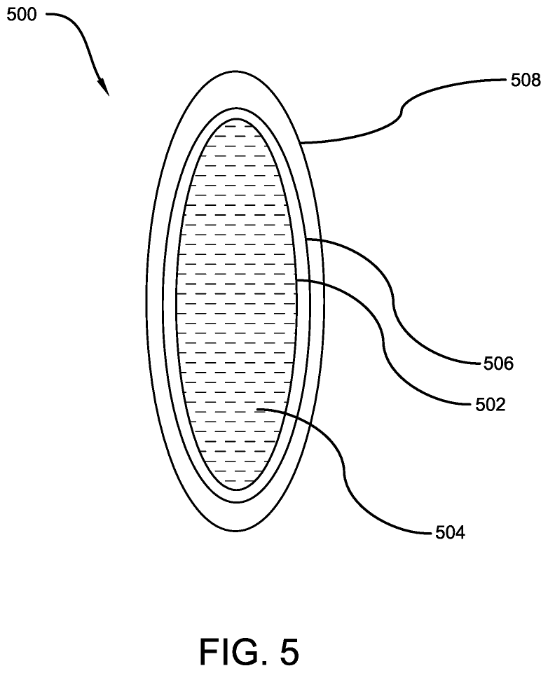

FIG. 5 illustrates a cross sectional view of another embodiment of the water-soluble beverage or consumable pod of the present invention in accordance with the disclosed architecture. In the present embodiment, the beverage or consumable pod 500 has a round shape and has a water dissolvable body 502 containing a consumable powder concentrate 504. The body 502 has a coating of a flavoring agent 506 for imparting a flavor in the consumable. A biodegradable cover 508 is configured to wrap the body 502 and protect same from moisture, water, and dirt.

Other shapes, designs, and configurations of the beverage pod 100 are contemplated and fall within the scope of the invention without affecting the utility of the device. Since the food grade paper body is dissolvable and the cover is biodegradable in various embodiments, no trash is generated when using the soluble coffee pod and therefore helps in maintaining the environment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dissolvable beverage pod”, “water-soluble beverage pod”, “coffee pod”, “tea pod” and “single-serving beverage pod” are interchangeable and refer to the environmentally friendly and water-soluble beverage pod 100, 500 of the present invention.

Notwithstanding the forgoing, the environmentally friendly and water-soluble beverage pod 100, 500 of the present invention can be of any suitable size and configuration as is known in the art without affecting the overall concept of the invention, provided that it accomplishes the above stated objectives. One of ordinary skill in the art will appreciate that the environmentally friendly and water-soluble beverage pod 100, 500 as shown in the FIGS. are for illustrative purposes only, and that many other sizes and shapes of the environmentally friendly and water-soluble beverage pod 100, 500 are well within the scope of the present disclosure. Although the dimensions of the environmentally friendly and water-soluble beverage pod 100, 500 important design parameters for user convenience, the environmentally friendly and water-soluble beverage pod 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

what is claimed is:

1. A beverage pod to instantly make coffee, the beverage pod comprising:
a biodegradable cover;
a sealed food grade paper body; and
a beverage powder for preparation of a single serving of a beverage;
wherein said beverage powder comprises a coffee powder;
wherein said sealed food grade paper body stored in said biodegradable cover;
wherein said biodegradable cover is waterproof;
wherein said sealed food grade paper body comprises a water-soluble material for dissolving in water, whereupon said beverage powder mixes with said water; and
wherein said water is selected from a group consisting of a hot water, a boiling water, and a cold water.

2. The beverage pod of claim 1, wherein said sealed food grade paper body having a coating comprising a flavoring agent.

3. The beverage pod of claim 2, wherein said sealed food grade paper body comprises a material of polyvinyl alcohol (PVOH).

4. The beverage pod of claim 3, wherein said sealed food grade paper body is airtight.

5. The beverage pod of claim 4, wherein said sealed food grade paper body comprises a round shape having a cavity for placing said beverage powder.

6. The beverage pod of claim 5, wherein said beverage powder comprises a volume from about 5 grams to about 25 grams.

7. The beverage pod of claim 6, wherein said sealed food grade paper body comprises a recyclable material.

8. The beverage pod of claim 7, wherein said sealed food grade paper body comprises a biodegradable material.

9. The beverage pod of claim 8, wherein said beverage powder comprises a flavor selected from a group consisting of a blueberry, a cinnamon, a chocolate, and a vanilla.

10. The beverage pod of claim 8, wherein said beverage powder comprises a coffee roast level.

11. A beverage pod to instantly make tea, the beverage pod comprising:
a biodegradable cover;
a sealed food grade paper body; and
a beverage powder for preparation of a single serving of a beverage;
wherein said beverage powder comprises a tea powder;
wherein said sealed food grade paper body stored in said biodegradable cover;
wherein said biodegradable cover is waterproof;
wherein said sealed food grade paper body comprises a water-soluble material for dissolving in water, whereupon said beverage powder mixes with said water; and
wherein said water is selected from a group consisting of a hot water, a boiling water, and a cold water.

12. The beverage pod of claim 11, wherein said sealed food grade paper body having a coating comprising a flavoring agent.

13. The beverage pod of claim 12, wherein said sealed food grade paper body comprises a material of polyvinyl alcohol (PVOH).

14. The beverage pod of claim 13, wherein said sealed food grade paper body is airtight.

15. The beverage pod of claim 14, wherein said sealed food grade paper body comprises a round shape having a cavity for placing said beverage powder.

16. The beverage pod of claim 14, wherein said sealed food grade paper body comprises a biodegradable material.

17. The beverage pod of claim 11, wherein said beverage powder comprises a flavor selected from a group consisting of a blueberry, a cinnamon, a chocolate, and a vanilla.

18. A method to instantly make a single serving of a consumable, the method comprising the steps of:
providing a consumable pod having a biodegradable cover, a sealed food grade paper body, and a consumable powder for preparation of a single serving of a consumable;
wherein said sealed food grade paper body stored in said biodegradable cover;
wherein said consumable powder surrounded by said sealed food grade paper body;
wherein said biodegradable cover is waterproof;
wherein said sealed food grade paper body is water-soluble;
unwrapping said biodegradable cover from said sealed food grade paper body;
placing said sealed food grade paper body with said consumable powder in water;
dissolving said sealed food grade paper body; and
releasing said consumable powder into said water.

19. The method of claim 18, wherein said water is selected from a group consisting of a hot water, a boiling water, and a cold water; and
further wherein said consumable powder is selected from a group consisting of a coffee powder, a tea powder, a baby formula powder, and a soup powder.

20. The method of claim 19, further comprising a step of coating said sealed food grade paper body with a flavoring agent.
